(19) United States
(12) Patent Application Publication
(10) Pub. No.: US 2026/0245780 A1
(43) Pub. Date: Aug. 20, 2026

(54) Patterned Magnetic Flux Structures and Applications

(71) Applicant: NVIDIA Corporation, Santa Clara, CA (US)

(72) Inventors: Youssef Elasser, Raleigh, NC (US); Sudhir Kudva, Dublin, CA (US); Mostafa Mosa, San Jose, CA (US)

(73) Assignee: NVIDIA Corporation, Santa Clara, CA (US)

(21) Appl. No.: 19/537,108

(22) Filed: Feb. 11, 2026

Related U.S. Application Data
(60) Provisional application No. 63/759,993, filed on Feb. 18, 2025.

(51) Int. Cl. H01F 17/04; H01F 17/00

(52) U.S. Cl. CPC H01F 17/04; H01F 17/0006; H01F 17/0013; H01F 17/0033; H01F 17/043

(57) ABSTRACT

A vertical patterned magnetic flux inductor system includes a magnetic core volume that defines a longitudinal gap extending horizontally through the center of the core volume. Top and bottom members of the core volume have slots therein. The slots are arranged such that the top and bottom members define complementary S shaped profiles when viewed in the z direction. Longitudinal electrical conductors are disposed partially in the slots and slope from the bottom member of the core to the top member of the core. A first terminal end of each conductor is exposed at the top side of the core volume and a second terminal end of each conductor is exposed at the bottom side of the core volume.

### CROSS-REFERENCE TO RELATED APPLICATIONS

This application claims benefit to the filing date of U.S. Provisional Application 63/759,993, filed Feb. 18, 2025 (the “Provisional Application”), the contents of which are hereby incorporated by reference as if entirely set forth herein. In the event of a conflict between the meaning of terms used in the Provisional Application and the same or similar terms as used herein, the meanings associated with this application shall control.

### BACKGROUND

Certain patterned magnetic flux coupled inductor devices were introduced by Elasser, et al., in US Patent Application Publication 20250079062 (the “062 Publication”), the contents of which are hereby incorporated as if entirely set forth herein. It was shown in the 062 Publication that the coupled inductor devices disclosed therein provided a number of advantages relative to uncoupled inductors when used in voltage regulator applications.

A first advantage provided by the coupled inductor devices of the 062 Publication in voltage regulator applications is that they can reduce per-phase current ripples, DC resistance, and magnetic core losses. These reductions can, in turn, improve the efficiency of the voltage regulator modules (“VRMs”) that incorporate the devices.

A second advantage provided by the coupled inductor devices of the 062 Publication in voltage regulator applications is that, for the same per-phase current ripple, the disclosed patterned magnetic flux inductor core can reduce the effective inductance that is seen during a load current transient. This reduced effective inductance improves the speed at which the voltage regulator responds to transients, which can result in a reduction in the amount of output capacitance required in a system design or to a reduction in voltage undershoot or overshoot for the same output capacitance.

A third advantage provided by the coupled inductor devices of the 062 Publication in voltage regulator applications is that, for the same per-phase current ripple and the same DC resistance, the disclosed patterned magnetic flux inductor can reduce the inductor footprint area required in an implementation while still achieving the above described improvement in transient response and reduction in magnetic core losses.

A need exists for devices that can provide some or all of the above advantages in a more power-efficient manner for vertical power delivery applications, in which all or part of the voltage regulator module is disposed vertically above or below the corresponding load. Moreover, a further need exists for structures that are capable of providing some or all of the above advantages for horizontal or lateral power delivery applications, in which all or part of the voltage regulator module is disposed at a horizontal or lateral offset relative to the corresponding load.

### BRIEF DESCRIPTION OF THE DRAWINGS

FIG. 1 is an exploded view illustrating an example vertically-oriented magnetic inductor core according to embodiments.

FIG. 2 is a top view of the magnetic inductor core of FIG. 1.

FIG. 3 is an oblique view of the bottom member of a vertically-oriented magnetic inductor core with sloped longitudinal electrical conductors disposed therein according to embodiments.

FIG. 4 is a side view illustrating a vertically-oriented inductor assembly containing sloped longitudinal electrical conductors and mounted to a horizontally-planar surface according to embodiments.

FIG. 5 is a side view of the sloped longitudinal electrical conductors of FIGS. 3 and 4.

FIGS. 6 and 7 are top views of a top or a bottom member of a vertically-oriented magnetic inductor core in which slots of the core adjoin sloped cutout portions of the core in accordance with embodiments.

FIG. 8 is a top view of a top or a bottom member of a vertically-oriented magnetic inductor core in which slots of the core do not adjoin sloped cutout core portions in accordance with embodiments.

FIG. 9 is a graph illustrating DC resistance versus slot depth in accordance with some vertical inductor assembly embodiments.

FIG. 10 is an exploded view illustrating front and back members of a horizontally-oriented magnetic inductor core according to embodiments.

FIG. 11 is a front view of the inductor core of FIG. 10.

FIG. 12 is an oblique view illustrating rod-shaped longitudinal electrical conductors suitable for use with the inductor core of FIG. 10.

FIG. 13 is an assembled view illustrating the inductor core of FIG. 10 with the rod-shaped longitudinal electrical conductors of FIG. 12 disposed therein according to embodiments.

FIG. 14 is an assembled view illustrating the inductor core of FIG. 10 with filled-type longitudinal electrical conductors disposed therein and substantially filling slots of the inductor core according to embodiments.

FIG. 15 is an oblique view illustrating example filled-type longitudinal electrical conductors suitable for use with the inductor core of FIG. 10 according to embodiments.

FIG. 16 is a top view of the inductor core of FIG. 10 with a y-gap dimension indicated thereon.

FIG. 17 is a front view of inductor core of FIG. 10 with an h-slot dimension indicated thereon.

FIGS. 18 and 19 are oblique views illustrating additional example filled-type longitudinal electrical conductors suitable for use with the inductor core of FIG. 10 according to embodiments.

FIG. 20 is an oblique view illustrating the electrical conductors of FIG. 15 with vertical extensions and horizontal tabs attached thereto or integrally formed therewith.

FIG. 21 is an assembled view illustrating the inductor core of FIG. 10 with the electrical conductors of FIG. 20 disposed therein according to embodiments.

FIGS. 22A-D are oblique views illustrating a first example assembly sequence for a horizontal inductor assembly according to embodiments.

FIGS. 23A-D are oblique views illustrating a second example assembly sequence for a horizontal inductor assembly according to embodiments.

FIG. 24 is a schematic diagram illustrating a buck converter voltage regulator in which inductor assemblies according to embodiments may be employed.

FIG. 25 is a side view illustrating a lateral power delivery application according to embodiments.

FIG. 26 is an oblique view illustrating a horizontal inductor assembly disposed inside a rectangular metal frame according to embodiments.

FIG. 27 is a side view illustrating the inductor assembly and metal frame of FIG. 26 in a lateral power delivery system in which an additional component is disposed vertically below the metal frame.

FIG. 28 is an oblique view illustrating an example additional electrical conductor that can be inserted into a horizontal inductor assembly to form a four-winding matrix coupled inductor assembly according to embodiments.

FIG. 29 is an assembled view illustrating a four-winding matrix coupled inductor assembly according to embodiments.

FIG. 30 is a front view illustrating the four-winding matrix coupled inductor assembly of FIG. 29 in a vertically stacked arrangement with other components on a printed circuit board according to embodiments.

FIG. 31 is a schematic diagram illustrating the buck converter voltage regulator of FIG. 24 with the coupled inductors of FIG. 24 replaced with a transformer circuit.

FIG. 32 is a top view illustrating two horizontal inductor assemblies coupled together to implement the transformer circuit of FIG. 31 according to embodiments.

FIG. 33 is a schematic view illustrating the buck converter voltage regulator of FIG. 31 implemented with the horizontal inductor assemblies of FIG. 32 acting as transformers according to embodiments.

### DETAILED DESCRIPTION

This disclosure describes multiple embodiments by way of example and illustration. It is intended that characteristics and features of all described embodiments may be combined in any manner consistent with the teachings, suggestions and objectives contained herein. For example, elements of a first described embodiment may be substituted for or combined with elements of any one or more other described embodiment to yield additional embodiments. Thus, phrases such as “in an embodiment,” “in one embodiment,” and the like, when used to describe embodiments in a particular context, are not intended to limit the described characteristics or features only to the embodiments appearing in that context.

The phrases “based on” or “based at least in part on” refer to one or more inputs that can be used directly or indirectly in making some determination or in performing some computation. Use of those phrases herein is not intended to foreclose using additional or other inputs in making the described determination or in performing the described computation. Rather, determinations or computations so described may be based either solely on the referenced inputs or on those inputs as well as others.

The phrase “configured to” as used herein means that the referenced item, when operated, can perform the described function. In this sense an item can be “configured to” perform a function even when the item is not operating and is therefore not currently performing the function. Use of the phrase “configured to” herein does not necessarily mean that the described item has been modified in some way relative to a previous state.

“Coupled” as used herein refers to a connection between items. Such a connection can be direct or can be indirect through connections with other intermediate items. Similarly, the phrase “thermal communication” as used herein refers to a thermally transmissive connection between two or more components. Such a thermally transmissive connection can be direct, as with direct contact between the components, or can be indirect, as through one or more intermediate thermally transmissive components.

Terms used herein such as “including,” “comprising,” and their variants, mean “including but not limited to.”

Articles of speech such as “a,” “an,” and “the” as used herein are intended to serve as singular as well as plural references except where the context clearly indicates otherwise. For example, articles of speech such as “a,” “an,” and “the,” when used in a claim or sentence subsequent to words such as “including,” “comprising,” or their variants, mean “one or more.” Terms used herein such as “substantially,” “about,” “approximately,” and their variants, mean within plus or minus ten percent of the associated reference quantity, item, or characteristic.

The phrase “vertical inductor assembly” and its equivalents as used herein refer to embodiments described below in which the terminal ends of the conductors in the inductor core are disposed proximate to the top and the bottom surfaces of the inductor core when the assembly is oriented for mounting on a horizontally-planar surface such as on a printed circuit board (“PCB”) or on an integrated circuit substrate or package, or in which a central longitudinal gap extends horizontally through the inductor core when the assembly is so oriented.

The phrase “horizontal inductor assembly” and its equivalents as used herein refer to embodiments described below in which the terminal ends of the conductors in the inductor core are disposed proximate to lateral surfaces (e.g., the front and the back surfaces) of the inductor core when the assembly is oriented for mounting on a horizontally-planar surface such as on a PCB or on an integrated circuit substrate or package, or in which a central longitudinal gap extends vertically through the inductor core when the assembly is so oriented.

### Vertical Patterned Magnetic Flux Inductor Systems

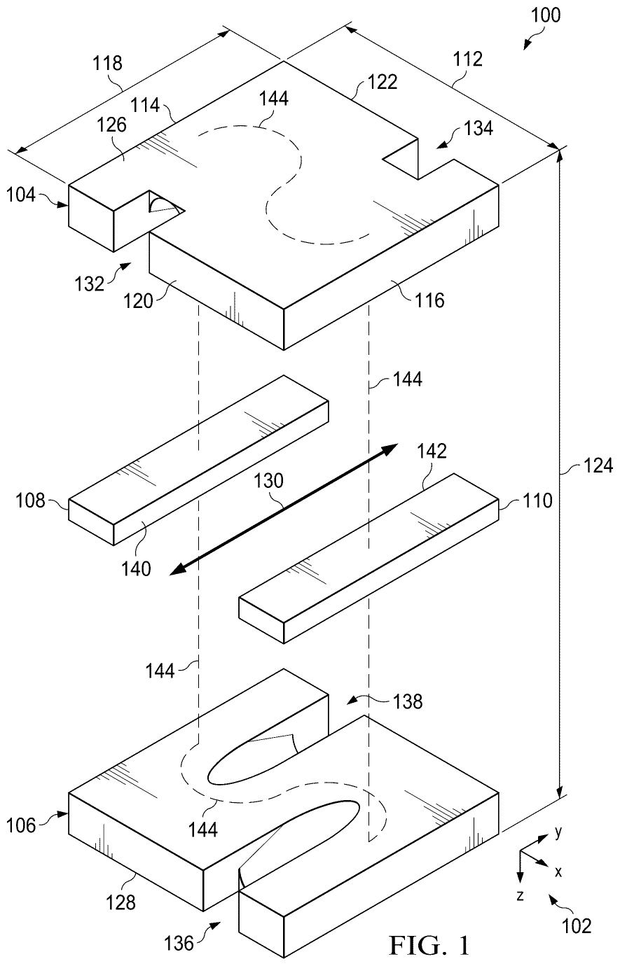

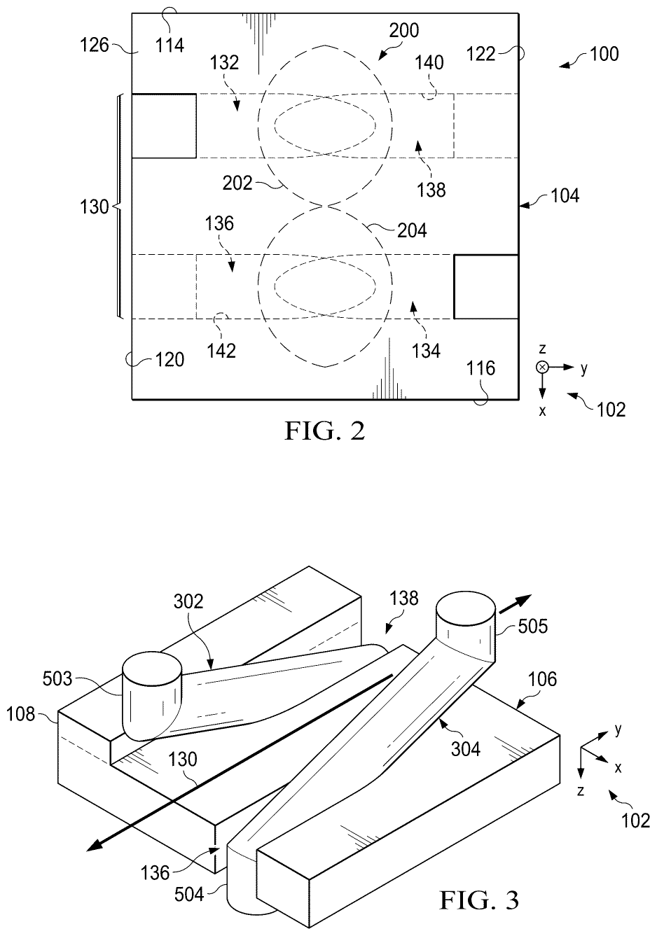

FIG. 1 is an exploded view illustrating an example vertically-oriented magnetic inductor core 100. FIG. 2 is a top view of the magnetic inductor core of FIG. 1. Mutually orthogonal axes x, y, and z are indicated at 102 in each of the figures. In the description that follows, the x and y directions correspond to a horizontal dimension, while the z direction corresponds to a vertical dimension.

In the illustrated embodiment, the inductor core comprises a top member 104, a bottom member 106, and two intermediate members 108, 110. In other embodiments, the inductor core may be formed as a unitary piece or may otherwise comprise a different number of constituent members than the illustrated embodiment comprises.

When assembled, the core members collectively define a rectangular core volume having a width 112 extending from a left side 114 to a right side 116 of the core volume in the x direction, a length 118 extending from a front side 120 to a back side 122 of the core volume in the y direction, and a depth 124 extending from a top side 126 to a bottom side 128 of the core volume in the z direction. The core volume further defines a longitudinal gap 130 that extends horizontally through the center of the core volume from its front side to its back side between the top and bottom members, as shown. The height of the longitudinal gap (measured in the z direction) corresponds to the height of the intermediate members. The width of the longitudinal gap (measured in the x direction) corresponds to the horizontal distance between the two inner faces 140, 142 of the intermediate members.

Each of the top and bottom members of the core includes a respective front slot 132, 136 that opens at the front side of the member and a back slot 134, 138 that opens at the back side of the member. Each of the slots is longitudinal, is oriented in the y direction, and extends partially through the member in which it is formed. Moreover each slot is disposed adjacent either to the left side of the longitudinal gap (face 140 of intermediate member 108) or to the right side of the longitudinal gap (face 142 of intermediate member 110), as shown. In various embodiments, the slots may be longer or shorter than those shown in the illustrated embodiment. Because corresponding slots in the top and bottoms members face in opposite directions (slots 132 and 138 open in opposite directions, and slots 134 and 136 also open in opposite directions), the top and bottom members form complementary S shaped profiles when viewed in the z direction.

When assembled, the members of the inductor core define a three-dimensional magnetic flux path 144 around longitudinal gap 130, as can be seen in FIG. 1. The projection of the flux path onto the x-y plane (see FIG. 2) forms a figure eight pattern 200 with its two lobes 202, 204 oriented in the x direction.

The inductor core of FIGS. 1 and 2 may be used to form various vertically-oriented inductor assemblies, some of which will now be described by way of example with reference to FIGS. 3-5.

Referring now to FIG. 3, the bottom inductor core member of an example vertically-oriented inductor assembly is shown in which two longitudinal electrical conductors 302, 304 are disposed partially within the slots of the bottom member. The two conductors are spaced apart in the x direction and are oriented such that, when the inductor core has been assembled, each conductor passes through the core volume and through the longitudinal gap in a respective y-z plane. Specifically, conductor 302 slopes upward from back slot 138 of the bottom member toward the front side of the bottom member, while conductor 304 slopes downward from the back side of the bottom member toward front slot 136 of the bottom member.

Note that, in the embodiment of FIG. 3, bottom inductor core member 106 is integrally formed with intermediate inductor core member 108. Similarly, in this embodiment, the top inductor core member 104 may be integrally formed with intermediate inductor core member 110. This configuration is shown by way of example and not by way of limitation. As was explained above, in various embodiments, the inductor core may be formed as a unitary piece or as an assembly of any number of discrete component pieces that are fixedly attached to one another or are otherwise held in a fixed relationship with one another.

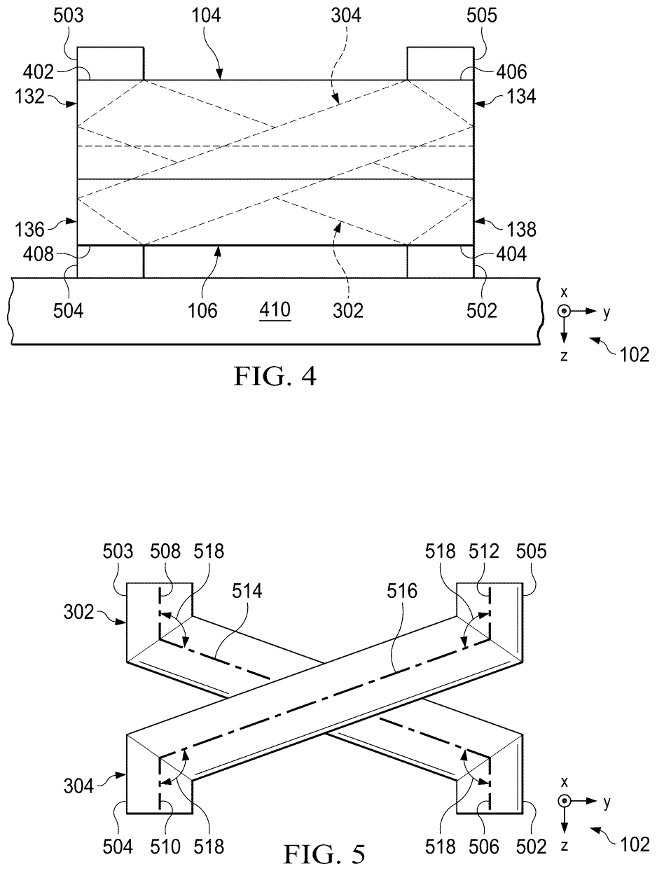

FIG. 4 presents a side view of the inductor assembly of FIG. 3 with the top member of the inductor core attached. As this view illustrates, conductor 302 is disposed partially in back slot 138 of bottom member 106 and partially in front slot 132 of top member 104, such that the conductor slopes upward from the back slot of the bottom member to the front slot of the top member. Similarly, conductor 304 is disposed partially in back slot 134 of top member 104 and partially in front slot 136 of bottom member 106, such that the conductor slopes downward from the back slot of the top member to the front slot of the bottom member. In this arrangement, the inductor core causes inverse coupling between the conductors when electric current flows through them in the same direction (e.g., when electric current flows through both conductors in the positive y direction), and the inductor core causes positive coupling between the conductors when electric current flows through them in opposite directions (e.g., when electric current flows through one conductor in the positive y direction and flows through the other conductor in the negative y direction).

Because of the existence and locations of the slots and the dispositions of the conductors within them, respective terminal ends 402, 406 of the conductors are exposed at the top side of the core volume, and respective terminal ends 404, 408 of the conductors are exposed at the bottom side of the core volume. The latter arrangement facilitates coupling the inductor assembly to one or more additional components 410 that are disposed vertically above or below the assembly. For example, exposed terminal ends of the conductors may be soldered to such an additional component. In some embodiments, the additional component may comprise a PCB that is generally planar in the horizontal dimension. In other embodiments, the additional component may comprise a driver and MOSFET (“DrMOS”) package, which may itself be mounted to a PCB. Other vertical configurations are also possible.

In some embodiments, at least one terminal end of one or both of the electrical conductors may include or be coupled to an electrically conductive vertical extension. For example, in the embodiment illustrated in FIGS. 3-5, conductor 302 includes vertical extension 502 at its lower terminal end and includes vertical extension 503 at its upper terminal end. Similarly, conductor 304 includes vertical extension 504 at its lower terminal end and includes vertical extension 505 at its upper terminal end. The vertical extensions may be integrally formed with the conductors or may comprise discrete members that are electrically coupled to the conductors, such as by soldering or brazing. Each of the vertical extensions may have a longitudinal extension axis 506, 508, 510, 512 (see FIG. 5), and each of the electrical conductors may have a longitudinal conductor axis 514, 516.

In such embodiments, the interior angles 518 indicated in FIG. 5 between the conductor axes and the extension axes may be greater than 90 degrees and less than 180 degrees. In this manner, although the extension axes are parallel with one another, the conductor axes are neither colinear with nor are orthogonal to the corresponding extension axes. Embodiments that incorporate this feature exhibit less current crowding at the junction between the longitudinal conductor and the vertical extension relative to devices in which the longitudinal conductor and the corresponding vertical extensions are orthogonal to one another. This reduction in current crowing results in a corresponding reduction in electrical resistance through a given sloped conductor (that is, between the ends of the upper and the lower vertical extensions of a given sloped conductor) relative to a corresponding horizontal conductor.

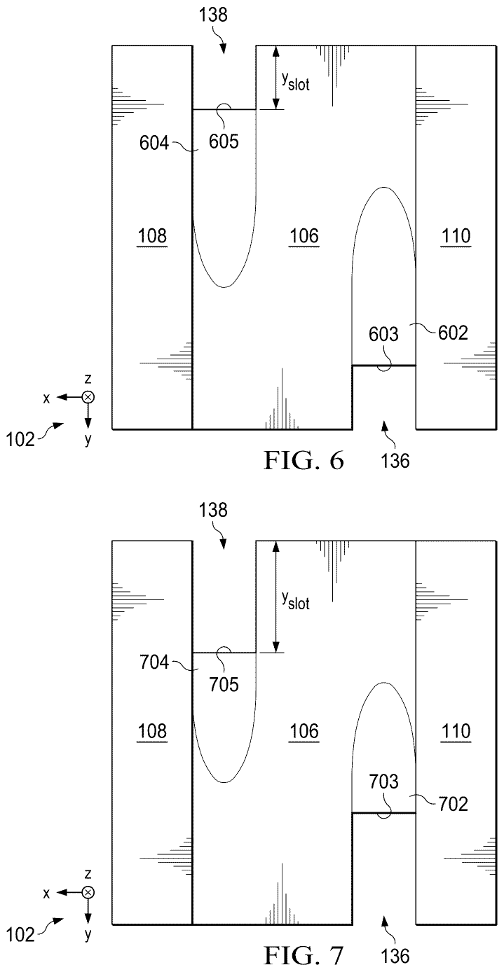

In further embodiments, both the upper and the lower members of the inductor core may define sloped cutout portions, each of which adjoins a respective inner end of one of the slots. In such embodiments, the cutout portions may be sloped in the y-z plane and may face the longitudinal gap in the core volume. The slope angles and contours of the cutout portions may be configured to receive a respective one of the electrical conductors. FIGS. 6 and 7 illustrate this by way of example.

FIG. 6 is a top view of an example bottom member 106 in which the length (y-slot) of each of the slots is approximately 15% of the overall length of the bottom member. Stated alternatively, the y-slot values in the embodiment of FIG. 6 are approximately 0.3 * y/2, where y is the length of the bottom member. As can be seen in the drawing, a cutout portion 602 formed in the bottom member adjoins an inner end 603 of slot 136, and a cutout portion 604 formed in the bottom member adjoins an inner end 605 of slot 138. Each cutout portion extends from the bottom side of the bottom member to the top side of the bottom member and may have a concave cross-sectional contour configured to receive a convex cross-sectional contour of one of the electrical conductors. In other embodiments, the electrical conductors and the cutout portions may have corresponding rectangular cross-sectional contours. Other contour combinations are also possible.

Moreover, the inner ends 603, 605 of the slots may themselves have different profiles than the embodiments shown in FIG. 6. For example, in the illustrated embodiments, the ends of the slots have straight profiles. In other embodiments, the ends of the slots may have curved profiles.

FIG. 7 is a top view of an example bottom member 106 in which the length (y-slot) of each of the slots is approximately 30% of the overall length of the bottom member. Stated alternatively, the y-slot values in the embodiment of FIG. 7 are approximately 0.6 * y/2, where y is the length of the bottom member. As can be seen in the drawing, a cutout portion 702 formed in the bottom member adjoins an inner end 703 of slot 136, and a cutout portion 704 formed in the bottom member adjoins an inner end 705 of slot 138. Like the example of FIG. 6, each cutout portion extends from the bottom side of the bottom member to the top side of the bottom member and may have a concave cross-sectional contour configured to receive the convex cross-sectional contour of one of the electrical conductors. In other embodiments, the electrical conductors and the cutout portions may have corresponding rectangular cross-sectional contours. As in the example of FIG. 6, other contour combinations are also possible.

Also like the example of FIG. 6, in various embodiments the inner ends 703, 705 of the slots may themselves have different profiles than the embodiment shown in FIG. 7. For example, in the illustrated embodiments, the ends of the slots have straight profiles. In other embodiments, the ends of the slots may have curved profiles.

In any embodiments, the dimensions and shapes of the cutout portions may vary based on the value of y-slot and the shape of the electrical conductors that are to be used in the given embodiment.

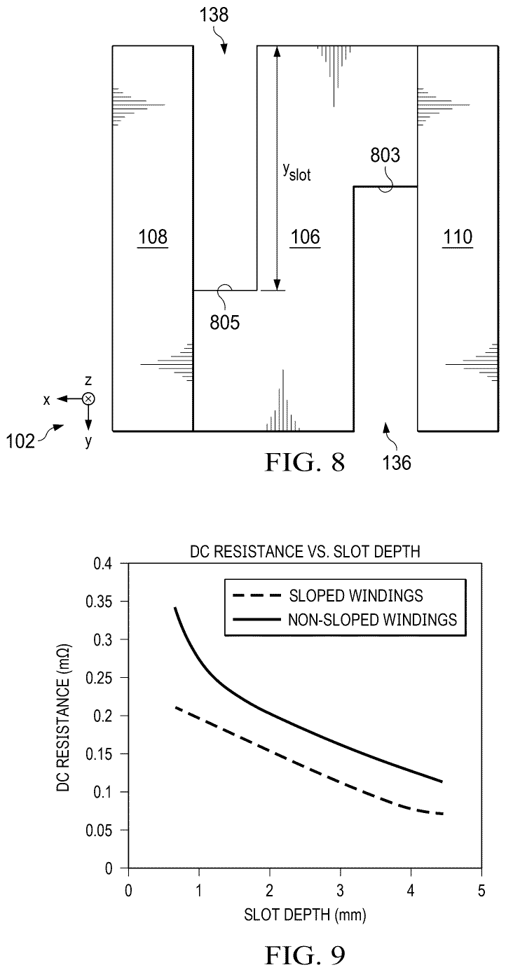

In still further embodiments, the cutout portions may be omitted. FIG. 8 illustrates such an embodiment by way of example. In the embodiment of FIG. 8, the y-slot values are greater than or equal to 50% of the overall length of the bottom member. Stated alternatively, the y-slot values in the embodiment of FIG. 8 are greater than or equal to y/2, where y is the length of the bottom member. As can be seen in the drawing, no cutout portions are defined in bottom member 106 in the embodiment of FIG. 8. Rather, the inner ends 803, 805 of slots 136, 138 extend vertically from the bottom side of the bottom member to the top side of the bottom member. Like the embodiments of FIGS. 6 and 7, however, the vertical profile of inner ends 803, 805 may be straight, as illustrated, or may be curved.

In any of the inductor systems described above that feature vertically sloped longitudinal conductors inside the inductor core, the vertical slope of the conductors results in a shorter path between the connection points at the top and the bottom sides of the inductor core relative to devices in which the longitudinal conductors inside the core are oriented horizontally. The shorter length of the conductors results in a smaller overall electrical resistance for the vertically sloped conductors relative to horizontally-oriented conductors. This reduced electrical resistance, in turn, results in lower power dissipation for sloped-conductor devices relative to devices that employ horizontally-oriented conductors. In addition, and as was explained above, in embodiments that feature vertical extensions at the ends of the conductors that pass through the inductor core, current crowding in the vertically sloped conductor embodiments is reduced relative to current crowding that occurs in horizontal conductor embodiments, which further reduces the electrical resistance exhibited by vertically sloped conductor embodiments relative to that exhibited by horizontal conductor embodiments.

FIG. 9 illustrates this reduction in electrical resistance for the conductors (i.e., the “windings”) in various embodiments as a function of the y-slot value (i.e., the “Slot Depth”). The upper curve in the graph represents DC resistance for embodiments in which the longitudinal conductors are horizontal with vertical extensions at each end oriented orthogonally to the longitudinal conductors (i.e., embodiments with “Non-Sloped Windings”), while the lower curve represents DC resistance for vertically sloped conductor embodiments as described above (i.e., those with “Sloped Windings”). As the graph illustrates, a relatively constant 0.05 mΩ reduction in resistance is achieve by the vertically sloped conductor embodiments relative to their non-sloped conductor counterparts. Given the fact that the total DC resistance for an inductor winding in such devices is on the order of 0.1 to 0.3 mΩ, the 0.05 mΩ reduction corresponds to a DC resistance reduction on the order of 16% to 50% for the device, which yields a correspondingly large reduction in power dissipation for the inductor assembly. In general, steeper slopes of the longitudinal conductors inside the core volume result in lower electrical resistance values for the conductors but larger core losses, while shallower slopes for the conductors result in higher electrical resistance for the conductors but smaller core losses.

In any of the vertically-sloped inductor embodiments described above, the height of the inductor core volume (in the z direction) may be smaller than the width of the core volume (in the x direction) and may be smaller than the length of the core volume (in the y direction). Devices exhibiting the latter proportions may be particularly beneficial in vertical power delivery application in which vertical space can be restrictive. Moreover, in any such embodiments, the width of the core volume may be equal to the length of the core volume, which may be beneficial for applications in the inductor assembly must be mounted above or below another component having a square profile in the horizontal dimension. In other embodiments, other dimensions and proportions may be used to suit the needs of a given application.

### Horizontal Patterned Magnetic Flux Inductor Systems

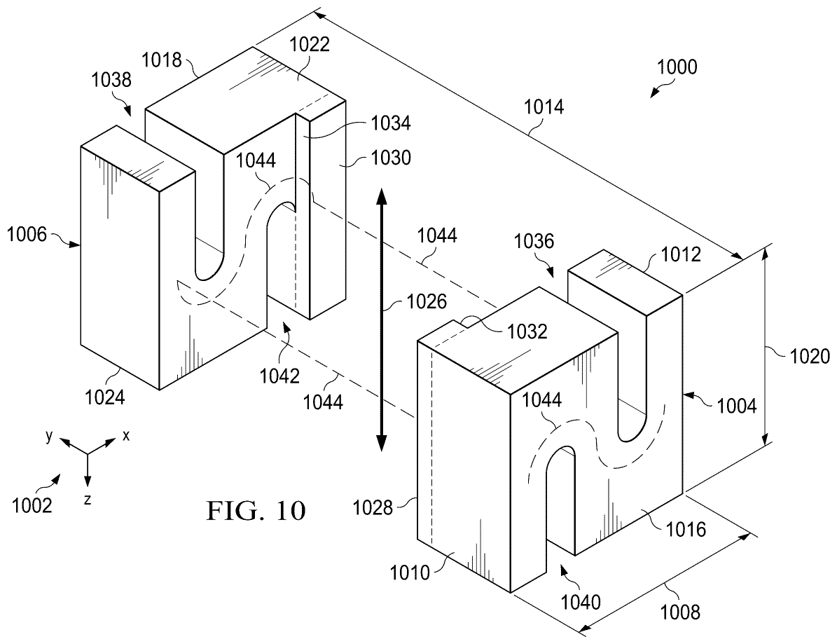

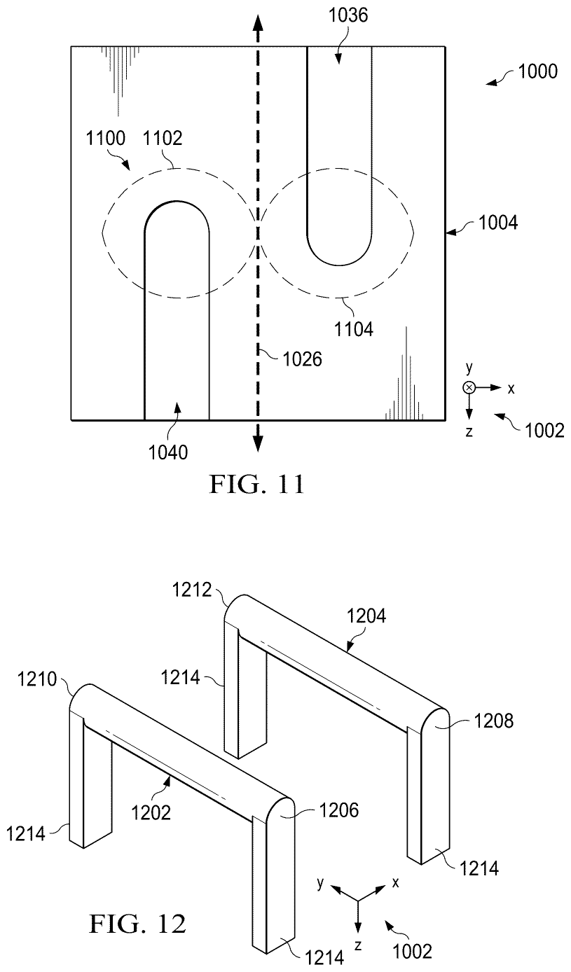

A first example horizontal magnetic inductor core will now be described with reference to FIGS. 10 and 11. FIG. 10 is an exploded view illustrating the example magnetic inductor core. FIG. 11 is a front view illustrating the inductor core of FIG. 11.

Referring now to FIG. 10, a magnetic inductor core 1000 is shown. Mutually orthogonal x, y, and z axes are indicated at 1002. In the description that follows, the x and y directions correspond to a horizontal dimension, while the z direction corresponds to a vertical dimension. In the illustrated embodiment, the inductor core comprises a front member 1004, and a back member 1006. In other embodiments, and as was described above in relation to the vertical inductor assembly, inductor core 1000 may formed as a unitary piece or may otherwise comprise a different number of constituent members than the illustrated embodiment comprises. For example, inductor core 1000 may include one or more intermediate members analogous to those described above in relation to the vertical inductor assembly.

When assembled, the core members collectively define a rectangular core volume having a width 1008 extending from a left side 1010 to a right side 1012 of the core volume in the x direction, a length 1014 extending from a front side 1016 to a back side 1018 of the core volume in the y direction, and a depth 1020 extending from a top side 1022 to a bottom side 1024 of the core volume in the z direction. The core volume further defines a longitudinal gap 1026 that extends vertically through the center of the core volume from its top side to its bottom side between the front and back members, as shown. The length of the longitudinal gap measured in the y direction corresponds to the length of members 1028, 1030 measured in the y direction.

The width of the longitudinal gap measured in the x direction corresponds to the distance between the two inner faces 1032, 1034 of the intermediate members as measured in the x direction.

Each of the front and back members of the core includes a respective top slot 1036, 1038 that opens at the top side of the member and a bottom slot 1040, 1042 that opens at the bottom side of the member. Each of the slots is longitudinal, is oriented in the z direction, and extends partially through the member in which it is formed. Moreover, each slot is disposed adjacent either to the left side of the longitudinal gap (face 1032 of member 1028) or to the right side of the longitudinal gap (face 1034 of member 1030), as shown. In various embodiments, the slots may be longer or shorter than those shown in the illustrated embodiment. Because corresponding slots in the front and back members face in opposite directions (slots 1038 and 1040 open in opposite directions, and slots 1036 and 1042 also open in opposite directions), front and back members form complementary S shaped profiles when viewed in the y direction.

When assembled, the members of the inductor core define a three-dimensional magnetic flux path 1044 around longitudinal gap 1026, as can be seen in FIG. 10. The projection of the flux path onto the x-z plane (see FIG. 11) forms a figure eight pattern 1100 with its two lobes 1102, 1104 oriented in the x direction.

The inductor core of FIGS. 10 and 11 may be used to form various horizontally-oriented inductor assemblies, some of which will now be described by way of example with reference to FIGS. 12-22.

FIG. 12 illustrates two horizontally-oriented longitudinal electrical conductors (rod-type conductors) 1202, 1204 that may be inserted in the slots of core 1000 so that the conductors are spaced apart from one another in the x direction and pass through the core volume and through the longitudinal gap. When the longitudinal conductors are so arranged, the inductor core causes inverse coupling between the conductors when electric current passes through the conductors in the same direction, but causes positive coupling between the conductors when electric current passes through the conductors in opposite directions.

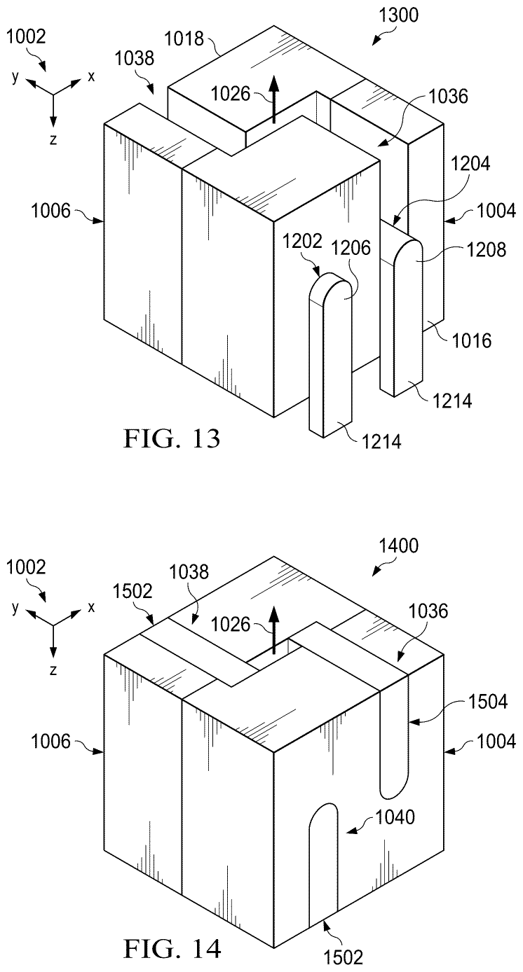

The resulting horizontal inductor assembly 1300 is shown at FIG. 13. Each of the longitudinal conductors has a front end 1206, 1208 exposed at the front side of the core volume and a back end 1210, 1212 exposed at the back side of the core volume. Moreover, at least one of the conductor ends may comprise an electrically conductive vertical extension 1214 reaching in the z direction at least to the bottom plane of the inductor core volume so that each of the front and back ends of the respective conductors is operable to make electrical contact with one or more additional components disposed at or below the plane of the inductor core volume. In the illustrated embodiment, the vertical members are integrally formed with the longitudinal conductors. In other embodiments, the vertical members may comprise separate discrete components that are electrically coupled to the ends of the longitudinal conductors, such as by soldering, brazing, or welding.

In some embodiments, the conductors that are disposed inside core 1000 may each comprise two blocks of conductive material, each block having a shape that substantially fills a corresponding void in the core volume that extends from a central portion of the core volume to the top or the bottom surface of the core volume (filled-type conductors). In some embodiments, the latter types of conductors may reduce the electrical resistance of the conductors relative to embodiments that feature rod-type conductors and may increase the ability of the conductors to dissipate heat relative to rod-type conductors.

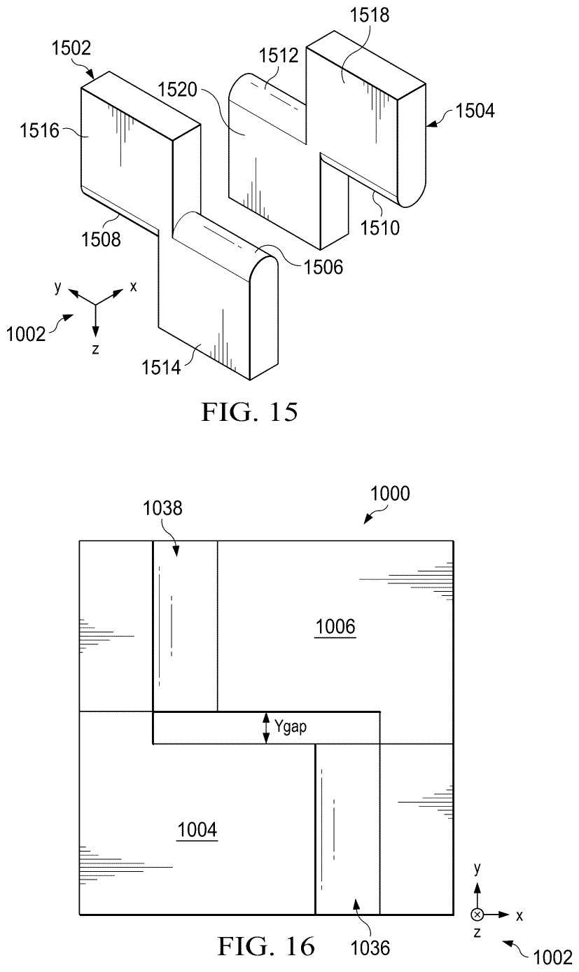

FIGS. 14 and 15 help to illustrate such filled-type conductor embodiments. FIG. 14 illustrates an assembled inductor assembly, while FIG. 15 illustrates electrical conductors 1502, 1504 that fit inside respective pairs of slots of the inductor core of FIG. 14.

Referring now to FIG. 14, an example inductor assembly 1400 is shown into which filled-type conductors 1502, 1504 have been inserted. Each of conductors 1502, 1504 includes at least one longitudinal portion 1506, 1508, 1510, 1512, but also includes a block of conductive material 1514, 1516, 1518, 1520 having a shape that fills a respective one of the voids in the core volume. For example, block 1514 fills the void that corresponds to slot 1040, which extends from a central portion of the inductor core to the bottom surface of the inductor core, while block 1516 fills the void that corresponds to slot 1038, which extends from a central portion of the inductor core to the top surface of the inductor core. Similarly, block 1518 fills slot 1036 of the inductor core and extends to the top surface of the core, while block 1512 fills slot 1042 and extends to the bottom surface of the core.

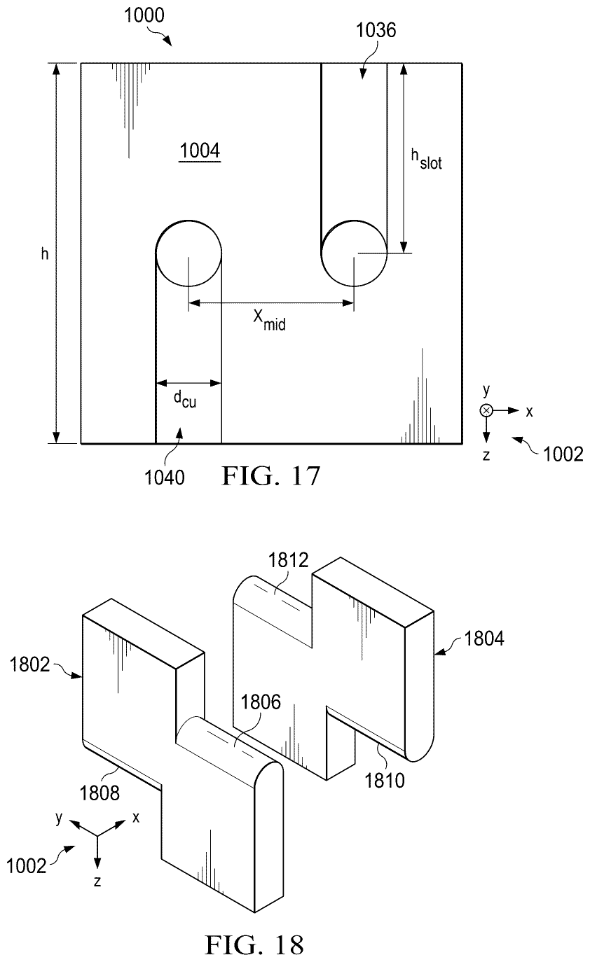

In various embodiments, the proportions of the conductive blocks may differ in a manner that corresponds to the longitudinal extent of the corresponding slots that are formed in the core. FIGS. 16-19 help to illustrate this. FIGS. 16 and 17 are top and front views, respectively, of core 1000. In these views, several dimensions are labeled for the sake of discussion. The y_{gap}dimension of FIG. 16 denotes the length of longitudinal gap in the y direction. The hₛₗₒₜdimension of FIG. 17 denotes the depth (the height) of the core slots measured in the z direction. The X_{mid} dimension of FIG. 17 denotes the center-to-center distance between the two longitudinal conductors in the x direction. The dₑᵤ dimension of FIG. 17 denotes the width of the longitudinal conductors in the x direction. In the case of rod-type conductors 1202, 1204, dₑᵤ corresponds to the diameter of the conductors. In various embodiments, each of these dimensions may vary from those illustrated.

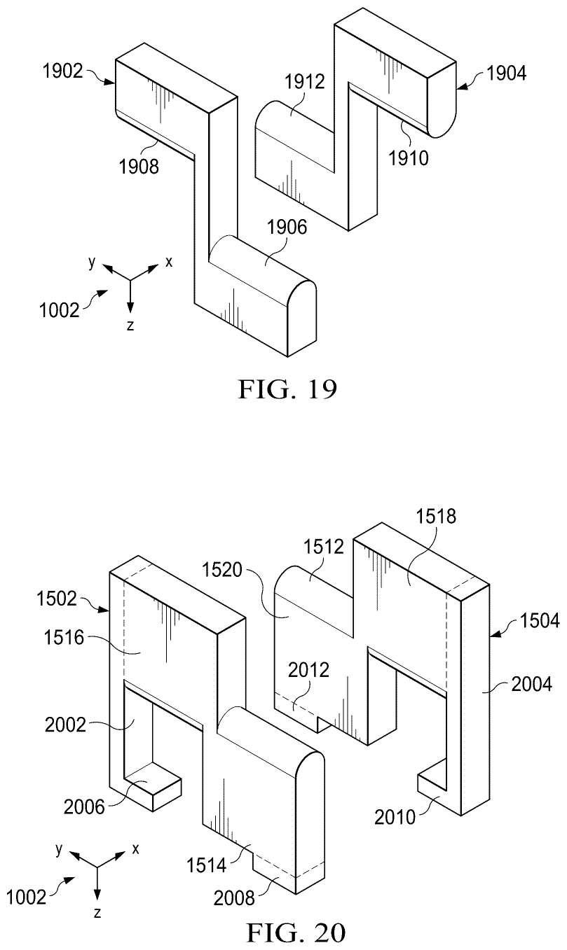

The conductors shown in FIG. 15 correspond to an inductor core in which the hₛₗₒₜdimension is approximately equal to h/2 plus dₑᵤ/2, where h denotes the depth or height of the inductor core in the z direction. By way of contrast, the proportions of conductors 1802, 1804 shown in FIG. 18 correspond to an inductor core in which the hₛₗₒₜ dimension is greater than h/2 plus dₑᵤ/2. By way of further contrast, the proportions of conductors 1902, 1904 shown in FIG. 19 correspond to an inductor core in which the hₛₗₒₜ dimension is less than h/2 plus dₑᵤ/2.

While the depth-wise proportions of the conductors vary in each embodiment, each conductor includes longitudinal portions in all of the embodiments, as indicated at 1806, 1808, 1810, 1812 in FIG. 18 and at 1906. 1908, 1910, 1912 in FIG. 19.

In any of the filled-type conductor embodiments described above (see FIGS. 14, 15, 18, and 19), an electrically conductive vertical extension 2002, 2004 may be coupled to one end of each of the conductors, for example as shown in FIG. 20. In some embodiments, the vertical extensions may be integrally formed with the block conductors, while in other embodiments the extensions may comprise separate components that are coupled to the block conductors, such as by soldering, brazing, or welding.

In still further embodiments, one or more electrically conductive horizontal tabs 2006, 2008, 2010, 2012 may be coupled to the conductors to further facilitate electrically coupling the inductor assembly to an additional component (such as a PCB) disposed vertically below the inductor assembly. As in the case of the vertical extensions, such horizontal tabs may be integrally formed with the block conductors, or the tabs may comprise separate components that are coupled to the block conductors, such as by soldering, brazing, or welding.

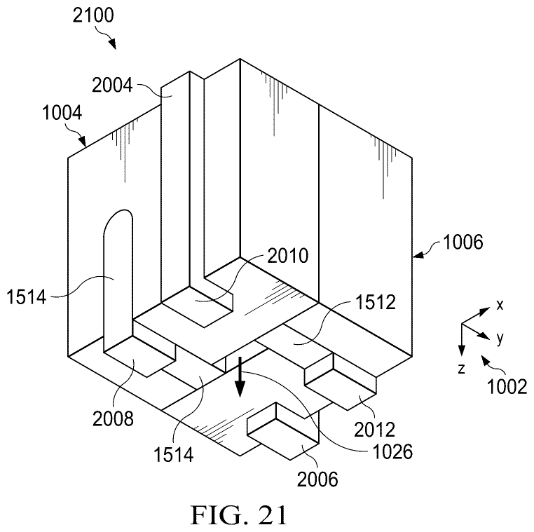

In any such embodiments, the resulting inductor assembly may resemble the example horizontal inductor assembly 2100 shown in FIG. 21. In the illustrated view of inductor assembly 2100, it can be seen that vertical extension 2004 reaches downward in the z direction to a point at or below the bottom plane of inductor core 1000, and that horizontal tabs 2006, 2008, 2010, 2012 are disposed just below the bottom plan of the inductor core.

While the longitudinal portions of the electrical conductors in the embodiments illustrated in FIGS. 13-21 are oriented horizontally within the inductor core, in other embodiments the longitudinal electrical conductors may be sloped, if desired, in a manner analogous to that of the sloped conductors in the vertical patterned magnetic flux inductor assemblies described above. In such embodiments, the longitudinal electrical conductors are oriented along respective y-z planes.

It is a feature of any of the horizontal inductor assemblies described above that all electrical connections to the ends of the conductors contained therein (including any associated vertical members or vertical extensions) can, if desired, be made on the same plane (e.g., at or below the bottom plane of the inductor core).

### Manufacture

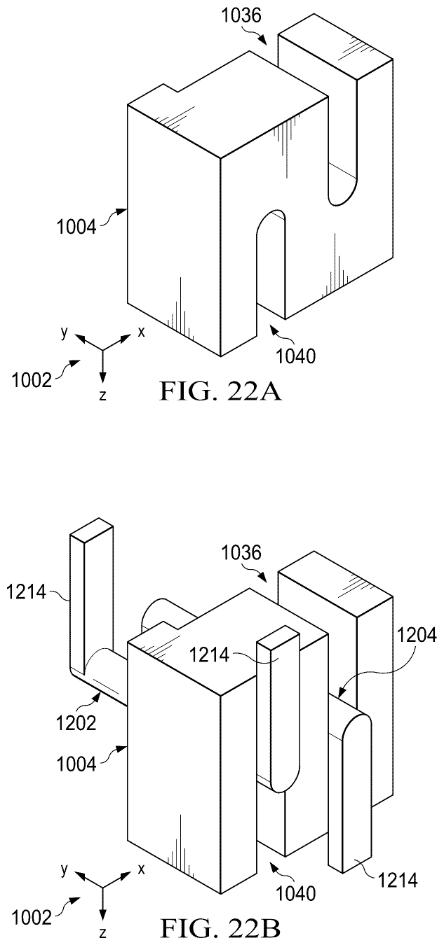

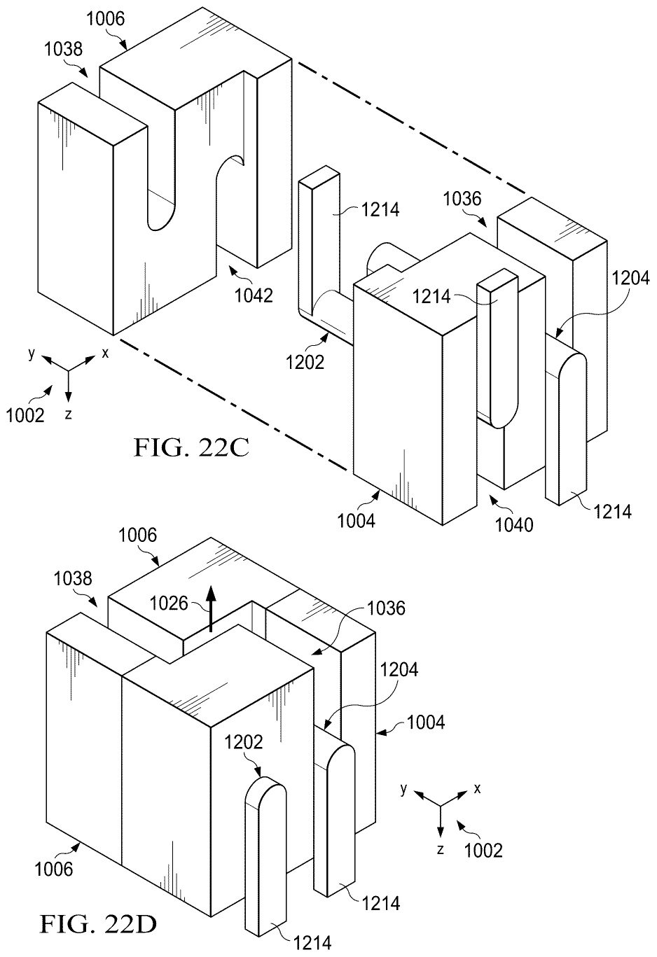

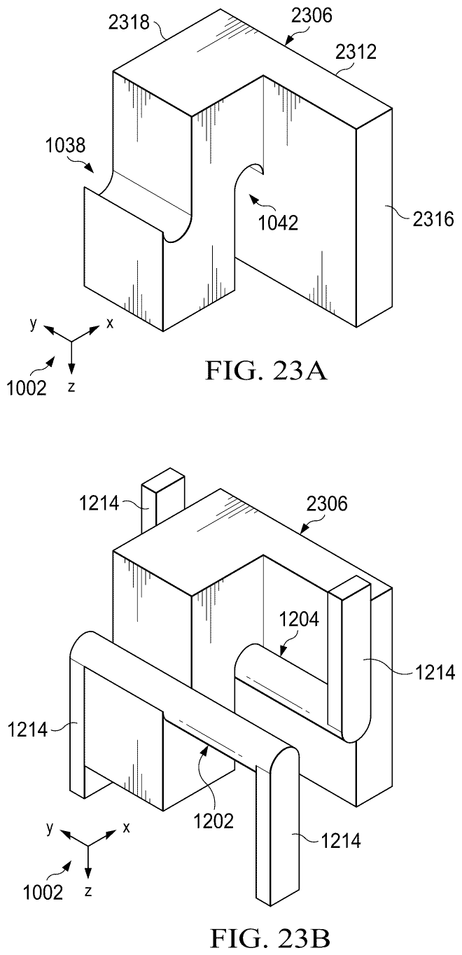

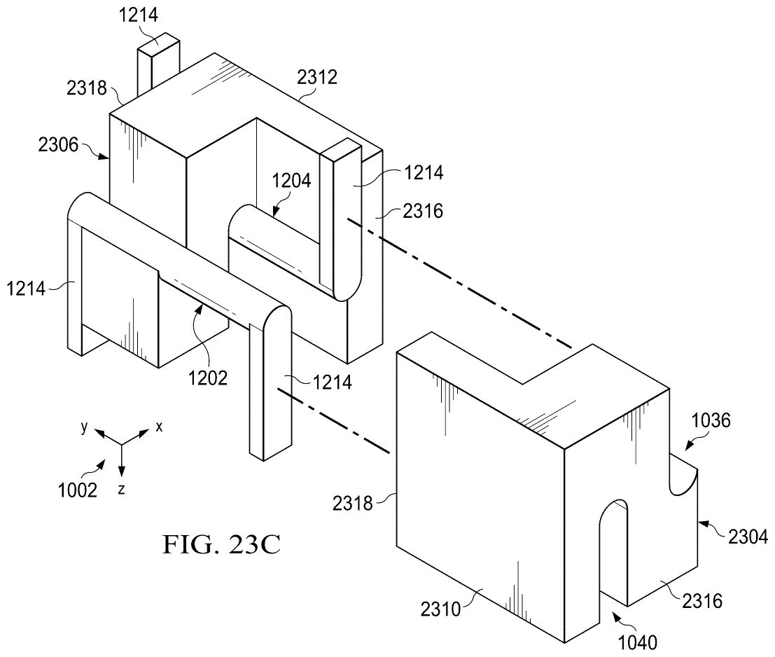

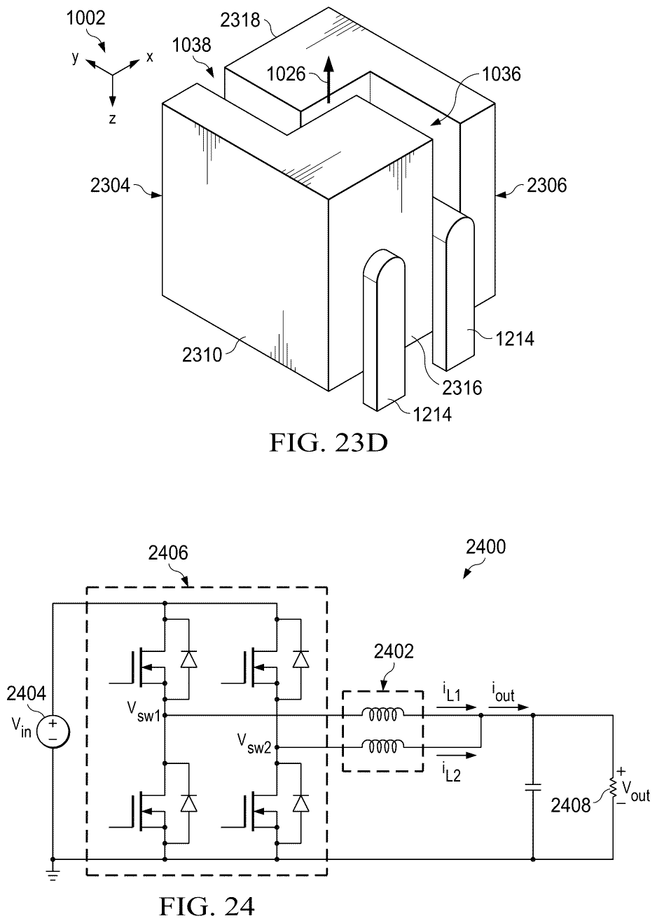

The inductor assemblies described above may be manufactured in a variety of ways, examples of which will now be described with reference to FIGS. 22A-D and FIGS. 23A-D.

FIGS. 22A-D illustrate an example assembly sequence for the manufacture of the inductor assembly of FIG. 13. In this sequence, vertical extensions 1214 may be attached to (or may be integrally formed with) rod-type conductors 1202, 1204 before the assembly begins. FIG. 22A depicts front member 1004 prior to the insertion of the rod conductors therein. At the step illustrated in FIG. 22B, rod conductors 1202, 1204 may be inserted into the slots of the front member, as shown. Note that, in this step, rod conductor 1204 is inserted with its vertical extensions pointing downward in the z direction, while rod conductor 1202 is inserted with its vertical extensions pointing upward in the z direction. As FIG. 22C illustrates, in the next step, the back member and the front member may be translated toward one another along the y axis, allowing the rod conductors and their respective vertical extensions to pass through the slots in the back member. As FIG. 22D illustrates, after the front and back members of the inductor core are in contact with one another, rod conductor 1202 may be rotated 180 degrees so that its vertical extensions point downward in the z direction, thus completing the assembly.

By way of further example, FIGS. 23A-D illustrate an assembly sequence for manufacturing an inductor assembly in which the front and back members of the inductor core volume have been cut along different planes than those of members 1004, 1006. In the embodiment of FIG. 23, the core members have been cut immediately adjacent to one of the slots such that left side 2310 of front member 2304 extends across the entire length of the core volume in the y direction from the front side 2316 of the core volume to the back side 2318 of the core volume. Similarly, the right side 2312 of back member 2306 extends across the entire length of the core volume in the y direction from the back side 2318 of the core volume to the front side 2316 of the core volume. Other variations of this sort are also possible.

FIG. 23A depicts back member 2306 prior to the insertion of the rod conductors therein. At the step illustrated in FIG. 23B, rod conductors 1202, 1204 may be inserted into the slots of the front member, as shown. Note that, in this step, rod conductor 1202 is inserted with its vertical extensions pointing downward in the z direction, while rod conductor 1204 is inserted with its vertical extensions pointing upward in the z direction. As FIG. 23C illustrates, in the next step, the front member and the back member may be translated along the y axis toward one another, allowing the rod conductors and their respective vertical extensions to pass through the slots in the front member. As FIG. 23D illustrates, after the front and back members of the inductor core are in contact with one another, rod conductor 1204 may be rotated 180 degrees so that its vertical extensions point downward in the z direction, thus completing the assembly.

Inductor assemblies according to FIG. 21 may be similarly constructed except that, in the latter cases, it may be desirable to attach vertical extensions 2004 and/or horizontal tabs 2008-2012 after the filled-type conductors have been assembled into the core volume.

### Lateral Power Delivery Applications

FIG. 24 illustrates an example power delivery application 2400 in which any of the inductor assembly embodiments described above may be employed. In this application, the longitudinal conductors of any of the above described inductor assemblies, along with a suitable MOSFET switching module, may be arranged to form a buck converter voltage regulator circuit that, when coupled to a supply voltage and to a load, can provide a regulated supply voltage to the load. In particular, the two longitudinal conductors in one of the above inductor assemblies may serve as the two coupled inductors shown at 2402 in the voltage regulator circuit. Input supply voltage 2404 is coupled to the supply rails of MOSFET switch module 2406, and the respective switch outputs of the MOSFET switching module are coupled to one end of each of the conductors in the inductor assembly, as shown. In this manner, electric current will flow in the same direction in each of the longitudinal conductors of the inductor assembly during operation of the buck converter circuit, such that the inductor assembly will produce inverse coupling between the two conductors during operation of the circuit. The other ends of the conductors in the inductor assembly are coupled to load 2408. The capacitor shown connected in parallel with the load represents one or more decoupling capacitors that may be placed in a variety of locations in and around the voltage regulator circuit (e.g., close to the load, and close to the inductor assembly).

In any such embodiments, MOSFET switch module 2406 may be implemented with one or more DrMOS packages, if desired. For example, module 2406 may be implemented with one DrMOS package that contains four MOSFET switches and the associated gate driver circuitry, or may be implemented with two DrMOS packages, each of which contains two MOSFET switches and the associated gate driver circuitry.

It is a feature of the horizontal inductor assemblies described above that, for power delivery applications of the type depicted in FIG. 24, the input ends of the two inversely coupled inductors are both located on one side of the inductor assembly (e.g., on the front side or the back side of the assembly), and the output ends of the two inductors are both located on the opposite side of the inductor assembly (e.g., on the back side or the front side of the assembly). This arrangement makes the horizontal inductor assemblies particularly suitable for lateral power delivery applications in which all or part of the voltage regulator circuit is disposed at a horizontal or lateral offset relative to the corresponding load.

For example, in the power delivery application 2400, the switched outputs V_{sw1} and V_{sw2} of switch module 2404 may be coupled the front ends of any of the horizontal inductor assemblies described above, and load 2408 may be coupled to the back ends of the inductor assembly.

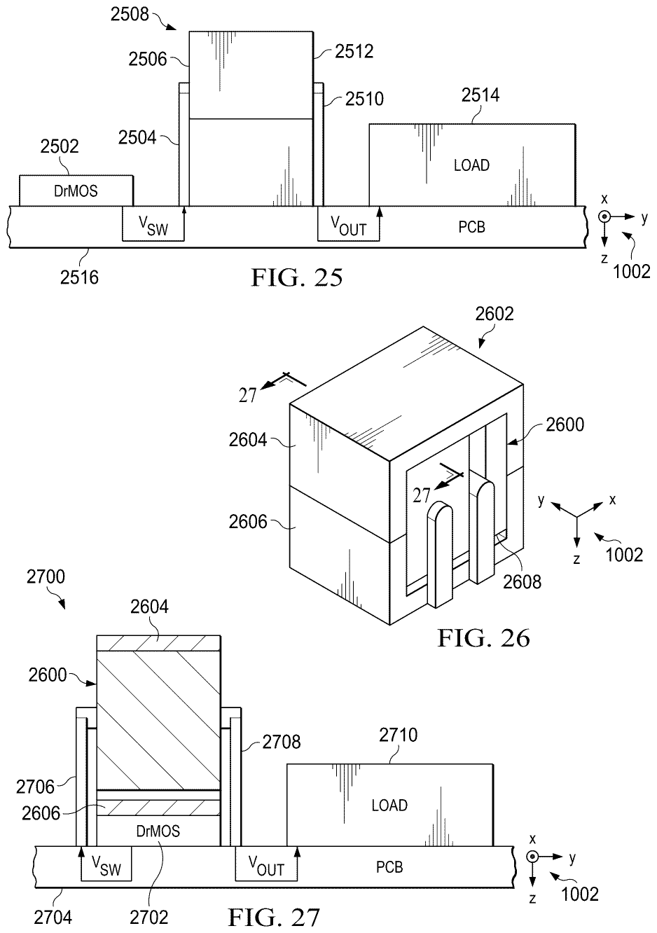

FIG. 25 helps to illustrate this. In the system depicted in FIG. 25, the switched outputs V_{sw} of one or more DrMOS packages 2502 are coupled to vertical extensions 2504 disposed at the front side 2506 of a horizontal inductor assembly 2508. Horizontal inductor assembly 2508 may be implemented using any of the varieties of horizontal inductor assemblies described above. Meanwhile, vertical extensions 2510 disposed at the back side 2512 of the horizontal inductor assembly are coupled to a load 2514. In this application, the signals provided by the inductor assembly at vertical extensions 2510 may represent the output voltage Vₒᵤₜ of the buck converter voltage regulator circuit of FIG. 24.

Each of the components may be mounted to a horizontally-oriented PCB 2516 at distinct horizontal locations thereon, as shown.

If desired, any of the horizontal inductor assemblies described above may also be mounted vertically above or below a switching module such as DrMOS package 2502. In the latter applications, a heat transfer jacket may be disposed around the perimeter of the horizontal inductor assembly to transfer heat away from the switching module disposed below the inductor assembly.

FIGS. 26 and 27 help to illustrate this. In FIG. 26, a horizontal inductor assembly 2600 (implemented according to any of the embodiments described above) is shown with a rectangular metal frame 2602 disposed around the top, bottom, left, and right sides of the inductor core of inductor assembly 2600. In the embodiment shown, the rectangular metal from comprises a top U-shaped member 2604 and a bottom U-shaped member 2606 in thermal communication with one another. In such embodiments, the top and the bottom U-shaped members may be coupled to one another, such as by soldering, brazing, or welding, to ensure both a mechanical and a thermal coupling between them. In other embodiments, different construction techniques may be employed for the rectangular metal frame. For example, in some embodiments, the frame may comprise a single integrally formed component.

Any non-magnetic material with appropriate thermal conductivity may be employed to form the metal frame. In some embodiments, for example, the frame may comprise copper.

Because the bottom member of the metal frame extends across the bottom side of the inductor assembly, the frame is capable of conducting heat from a component disposed below the inductor assembly to locations above the component, including to the top member of the metal frame. The gap 2608 shown in the drawing between the bottom of the inductor core and bottom member of the metal frame need not be present in embodiments. The gap serves to illustrate, however, that the mechanical fit between the inductor core and the metal frame need not be precise, as the majority of the heat in a buck converter voltage regulator circuit will be generated by the switching module that would be disposed directly below the bottom member of the metal frame in thermal communication with the bottom member of the metal frame. Thus, the metal frame need not be disposed so tightly around the inductor core that it also conducts heat away from the inductor core, although in some embodiments a tight fit of the metal frame around the inductor core may be employed.

FIG. 27 illustrates a power delivery application 2700 in which the inductor assembly and metal frame of FIG. 26 are mounted above a DrMOS package in a buck converter voltage regulator circuit. In FIG. 27, the inductor assembly and metal frame are shown in a cross-sectional view taken across the section 27-27 indicated in FIG. 26. In power delivery application 2700, DrMOS package 2702 is mounted to a horizontally oriented PCB 2704 such that the package is disposed directly below, and is in thermal communication with, bottom member 2606 of metal frame 2602. Switched outputs V_{sw} of the DrMOS package are shown coupled to vertical extensions 2706 located on one side of the inductor assembly, while the output voltage Vₒᵤₜ of the buck converter circuit are shown coming from vertical extensions 2708, which are located on the opposite side of the inductor assembly from extensions 2706. The output voltage is, in turn, coupled to a load 2710 that is disposed at a distinct horizontal location on the PCB from the vertically stacked inductor assembly and DrMOS package. In further embodiments, an additional heat sink may be thermally coupled to the top member 2604 of the metal frame to remove heat from the DrMOS package more efficiently.

In some embodiments, the assembly of FIG. 27 may be constructed by first mounting the DrMOS package to the PCB, and then attaching the bottom U-shaped member of the metal frame to the top surface of the DrMOS package with a thermally conductive paste. The inductor assembly may then be placed over the bottom U-shaped member and mounted to the PCB. Finally, the top U-shapped member may be attached to the bottom U-shaped member as described above. In other embodiments, other construction sequences and techniques may be employed.

### Matrix Coupled Inductor Applications

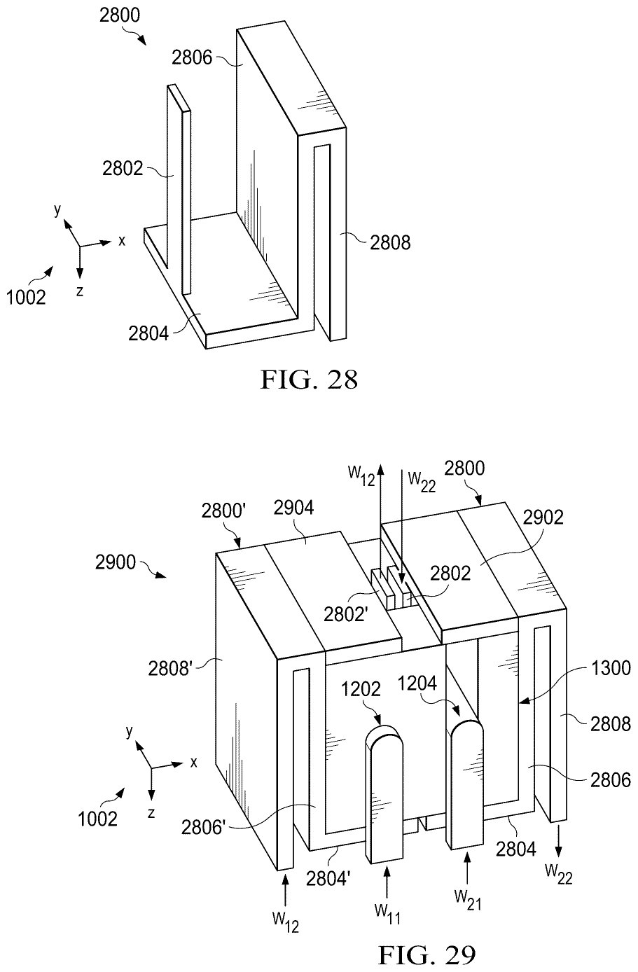

In further applications, any of the above described horizontal inductor assemblies may be used to create novel four-winding matrix coupled inductor structures. Such matrix coupled inductor structures may be used, for example, in a variety of pulse width modulated power conversion applications, as persons having skill in the art will appreciate. An example embodiment of such a four-winding matrix coupled inductor structure will now be described with reference to FIGS. 28-30.

Referring now to FIG. 28, two electrical conductors may be constructed having the general shape represented by example electrical conductor 2800. Conductor 2800 includes a first vertical member 2802 with dimensions designed to fit inside, and to extend through, the longitudinal gap 1026 of any of the horizontal inductor assemblies describe above. Conductor 2800 also includes a horizontal member 2804 with dimensions designed to fit outside, and to extend along, the bottom side of the horizontal inductor assembly. Conductor 2800 further includes a second vertical member 2806 designed to fit outside, and to extend along, the right or the left side of the horizontal inductor assembly. In some embodiments, conductor 2800 may additionally include a vertical return member 2808 that extends from the top end of member 2806 downward to at least the bottom plane of the core volume of the horizontal inductor assembly.

By way of example, FIG. 29 illustrates a four-winding matrix coupled inductor assembly 2900 that may be formed using the electrical conductors of FIG. 28 and the horizontal inductor assembly of FIG. 13. To form the structure, vertical members 2802, 2802′ of electrical conductors 2800 and 2800′, respectively, are inserted into vertical longitudinal gap 1026 until horizontal members 2804, 2804′ are in contact with the bottom side of the inductor core of inductor assembly 1300 and vertical members 2806, 2806′ are in contact with the right and left sides of the inductor core, respectively. In various embodiments, the size of longitudinal gap 1026 and/or the size of vertical members 2802, 2802′ may be varied to ensure an appropriate fit between them.

In some embodiments, an electrically insulative material may be placed between vertical members 2802, 2802′ inside gap 1026, and/or between horizontal members 2804, 2804′ to prevent an electrical short between the conductors 2800, 2800′. Such an insulative material may, for example, comprise solder mask applied to the inner surfaces of one or more of vertical members 2802, 2802′, or may comprise an electrically insulative insert, such as an adhesive tape or a plastic sheet. In other embodiments, other types of insulative material may be used.

Once the pieces have been assembled as shown in FIG. 29, vertical member 2802, horizontal member 2804, and vertical member 2806 collectively form a three-quarter turn winding around longitudinal conductor 1204 from the top of member 2802 (disposed at the top of the longitudinal gap in the core volume) to the top of vertical member 2806 (disposed adjacent to the top right edge of the core volume). Similarly, vertical member 2802′, horizontal member 2804′, and vertical member 2806′ collectively form a three-quarter turn winding around longitudinal conductor 1202 from the top of member 2802′ (disposed at the top of the longitudinal gap in the core volume) to the top of vertical member 2806′ (disposed adjacent to the top left edge of the core volume). The device therefore has four windings, labeled in FIG. 29 as W11, W12, W21, and W22.

In applications, the matrix coupled inductor structure may be coupled to external circuitry such that electrical current flows into windings W11 and W21 on the front side of inductor assembly 1300 and exits windings W11 and W21 on the back side of inductor assembly 1300. The same external circuitry may be configured to cause electrical current to flow into winding W22 at the top of vertical member 2802 and out of winding W22 at the bottom of return member 2808, and to cause electrical current to flow into winding W12 at the bottom of return member 2808′ and out of winding W12 at the top of vertical member 2802′, as indicated by the arrows in FIG. 29.

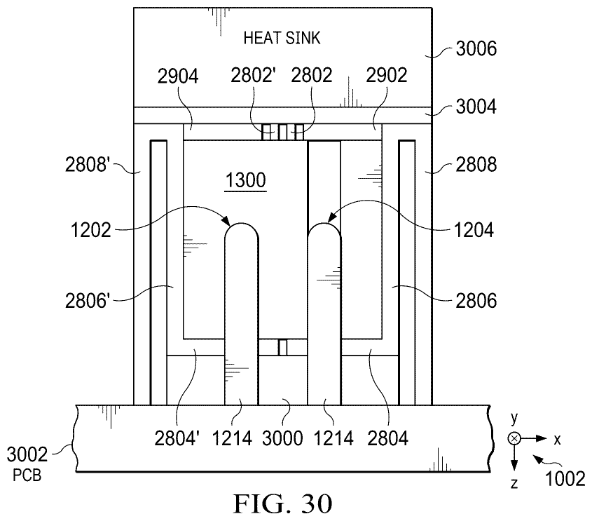

In some embodiments, thermally conductive lateral members 2902, 2904 may be placed over the core volume and in thermal communication with conductors 2800, 2800′, respectively. In the latter embodiments, conductors 2800, 2800′ and lateral members 2902, 2904 may function to transfer heat upward from a component that is disposed below the four-winding matrix coupled structure, as will be further described with reference to FIG. 30.

FIG. 30 illustrates an example system in which the four-winding matrix coupled structure of FIG. 29 may be vertically stacked with another component disposed between the matrix coupled structure and a PCB. In FIG. 30, matrix coupled inductor structure 2900 is shown mounted over an additional component 3000 disposed below it, where the additional component is itself mounted to a PCB 3002. The additional component may be, for example, a DrMOS package. Because the top surface of the additional component is in thermal communication with horizontal members 2804, 2804′, conductors 2800, 2800′ function to transfer heat upward from the top surface of the additional component. If desired, an electrically non-conductive but thermally conductive interface material 3004 may be placed across the top of the matrix coupled structure, as shown, and a heat sink 3006 may be placed above the structure in thermal communication with the interface material. Meanwhile, the windings of the matrix coupled inductor structure may be coupled to external circuitry through traces in the PCB via vertical extensions 1214 and return members 2808, 2808′. In such embodiments, electrical connections may be provided to the tops of windings W12, W22 through the front and/or the back sides of the structure.

### Trans-Inductor Voltage Regulator Applications

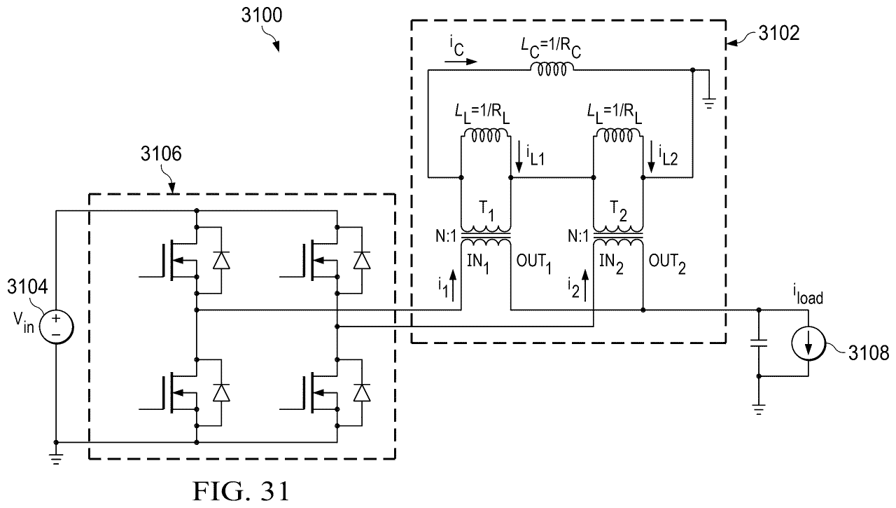

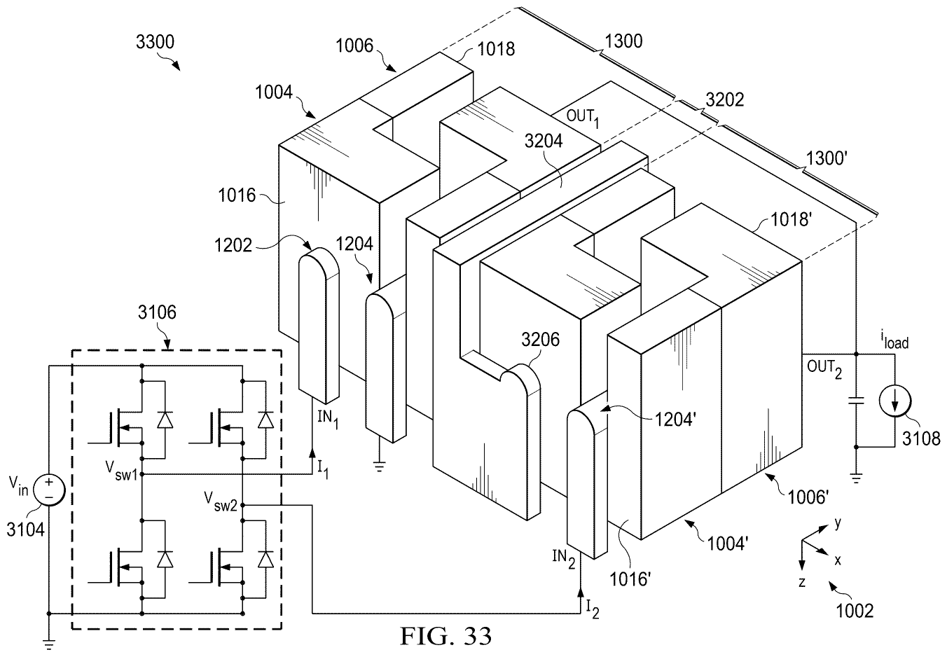

Persons having skill in the art have observed that the behavior of inversely coupled inductors may be modeled with the equivalent circuit shown at 3102 in FIG. 31, and that the behavior of inversely coupled inductors may be realized in actual circuits by directly implementing the transformers and the inductances connected as shown in the equivalent circuit. For example, FIG. 31 illustrates a buck converter voltage regulator 3100 that is similar to the circuit of FIG. 24 except that, in the circuit of FIG. 31, inversely coupled inductor device 2402 is replaced by the components of equivalent circuit 3102. Specifically, in the circuit of FIG. 31, input voltage source 3104 is coupled across the supply rails of MOSFET switching module 3406, and each of the switched outputs of module 3106 is coupled to one end of the primary winding of a respective one of transformers T1 and T2 in the equivalent circuit. The other ends of the primary windings of the two transformers are coupled to load 3108. As was the case in FIG. 24, the capacitor shown connected in parallel with the load in FIGS. 31 and 33 represents one or more decoupling capacitors that may be placed in a variety of locations in and around the voltage regulator circuit (e.g., close to the load, and close to the inductor assembly).

In some embodiments, any of the horizontal inductor structures described above may be used as transformers to create a novel structure that implements the equivalent circuit 3102 shown in FIG. 31.

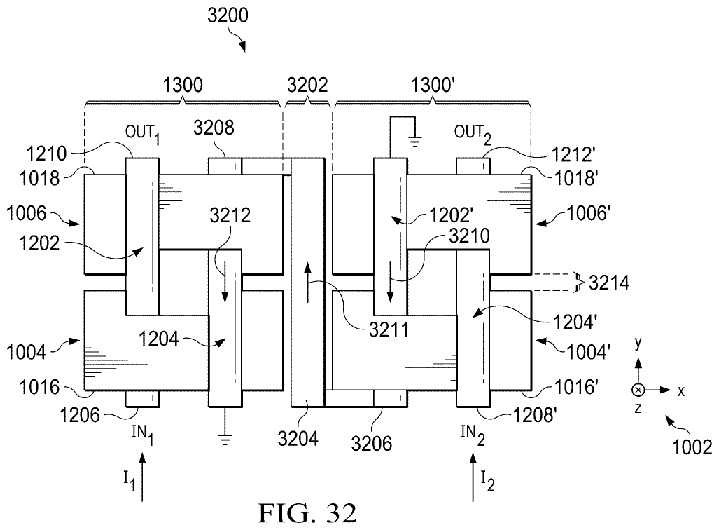

FIG. 32 illustrates an example of such a structure at 3200. As illustrated, structure 3200 is implemented using two horizontal inductor assemblies 1300, 1300′, where each of the two horizontal inductor assemblies may be constructed according to the embodiment illustrated in FIG. 13. Embodiments according to of FIG. 13 are used in this example for the sake of illustration only. In other embodiments, any of the other horizontal inductor assemblies described above may be used.

Referring now to FIG. 32, inductor assemblies 1300, 1300′ are disposed horizontally adjacent to one another with a lateral space 3202 between them. The lateral space extends from the front sides 1016, 1016′ to the back sides 1018, 1018′ of the core volumes of the two horizontal inductor assemblies. The core volumes of the two inductor assemblies are oriented such that the longitudinal conductors that pass through them (conductors 1202, 1204, 1202′, and 1204′) are oriented in parallel planes, as shown. (As was mentioned above, in various embodiments the longitudinal portions of the conductors may be horizontally oriented or may be sloped.) In this arrangement, each of the inductor assemblies forms a 1:1 transformer having an inner winding (1204 or 1202′) disposed proximate to lateral space 3202 and an outer winding (1202 or 1204′) disposed farther from the lateral space. An additional electrical conductor 3204 is coupled to the front end 3206 of the inner winding of the right-hand transformer and is coupled to the back end 3208 of the inner winding of the left-hand transformer. The other ends of the inner windings may be coupled to ground, as shown.

In this arrangement, winding 1202 corresponds electrically to the primary winding of transformer T1 in circuit 3102. Similarly, winding 1204′ corresponds electrically to the primary winding of transformer T2 in circuit 3102. In such an embodiment, the magnetizing inductance of the two transformers correspond to the respective L_{L} values in circuit 3102, and the combined leakage inductance of the two transformers may correspond to the Lc value in circuit 3102. In other embodiments, a separate discrete inductor may be placed between one end of the inner windings and ground to represent the L_{c} value in circuit 3102.

Note that, when electric current flows into the outer windings of both devices in the same direction, as indicated by arrows I₁ and I₂ in FIG. 32, this causes an induced current to flow in the inner windings of each device in a direction opposite to that of the current flowing in the corresponding outer winding, as indicated at arrows 3210, 3212 (current flows in direction 3211 in conductor 3204). Consequently, the behavior of the horizontal inductor assemblies in this arrangement is to cause positive coupling between conductors 1202 and 1204 in the left-hand device, and to cause positive coupling between conductors 1202′ and 1204′ in the right-hand device. For this reason, in some embodiments, it may be desirable to incorporate a gap 3214 between the front members 1004, 1004′ and the back members 1006, 1006′ of the two devices to avoid unwanted saturation in the inductor cores. The existence and the size of such a gap may be used to modulate the reluctances in the device to yield a saturation point that is acceptable given the current levels and frequencies at which the device is expected to operate. If desired, gap 3214 may be filled with a non-magnetic material such as plastic to ease manufacture.

FIG. 33 illustrates the device of FIG. 32 being used in the circuit of FIG. 31 to implement a trans-inductor voltage regulator system 3300. In system 3300, MOSFET switch module 3106 is electrically coupled to transformers 1300, 1300′ at In₁ and In₂, as shown. Specifically, a first switch pair in the switch module (Vsw1) is coupled to the input end (In1) of the outer winding of transformer 1300, and a second switch pair in the switch module (Vsw2) is coupled to the input end (In2) of the outer winding of transformer 1300′. Meanwhile load 3108 is coupled to transformers 1300, 1300′ at the other ends of their respective outer windings (at Out₁ and Out₂).

It is a feature of system 3300 that the outer windings of each transformer has an input end 1206 (In₁), 1208′ (In₂) at the front side 1016, 1016′ of the transformer and has an output end 1210 (Out₁), 1212′ (Out₂) at the back side 1018, 1018′ of the transformer. This arrangement is particularly useful in lateral power delivery applications, in which all or part of the voltage regulator module is disposed at a horizontal or lateral offset relative to the corresponding load. For example, in such applications, the MOSFET switching module and the load may be located on opposite sides of the transformer assembly represented by transformers 1300, 1300′.

In the embodiment of FIG. 33, the front and back members of the inductor cores are shown without gap 3204 between them, to illustrate that gap 3204 may or may not be included, depending on the needs of the application at hand.

Additional conductor 3204 may be implemented in a variety of ways in various embodiments. In some embodiments, for example, the conductor may comprise a metal volume disposed inside and substantially filling lateral space 3202, as in the illustrated embodiment. In other embodiments, the conductor may comprise a trace on a PCB to which transformers 1300, 1300′ are mounted. In further embodiments, the additional conductor may comprise a wire. Other variations are also possible. In general, a conductor 3204 having a larger volume may exhibit commensurately lower electrical resistance than a conductor 3204 that has a smaller volume.

### Materials

Magnetic cores according to any of the above-described embodiments may be constructed using any of a variety of magnetic materials. For example, in some embodiments, a manganese-zinc ferrite material may be used such as any of the ML91S or ML95S Mn-Zn soft ferrite core materials available from Proterial America, Ltd. In other embodiments, a nickel-zinc ferrite material may be used. Various other ferrite materials may also be used in embodiments, in accordance with requirements of the host systems in which the respective inductor components will be deployed.

Electrical conductors used in embodiments may comprise any electrically conductive material. For example, the electrical conductors may comprise copper.

### Dimensions

The length, width, and depth or height dimensions of all of the vertical and horizontal inductor assemblies described above may be varied according to the needs of an application and the desired operating characteristics for the device.

It is a feature of the vertical inductor assemblies described above that the depth or height dimension (measured in the z direction) of the device may be smaller than either of the length or the width dimensions of the device without incurring unacceptable core losses. For example, in some embodiments, the width and length dimensions of the inductor core volume in a vertical embodiment may be on the order of 6 mm and 6 mm, respectively, while the depth or height dimension may be on the order of 1.5 mm. Proportions such as these enable the vertical inductor assemblies described above to be particularly beneficial in vertical power delivery and other applications in which the overall vertical height of the assemblies may be constrained. In other embodiments, other dimensions and proportions may be used.

It is a feature of the horizontal inductor assemblies described above that the terminal ends of the conductors therein are electrically accessible on the lateral sides of the device. This feature enables the horizontal inductor assemblies described above to be particularly beneficial in horizontal or lateral power delivery and other application in which it is desirable to dispose related components at lateral or horizontal offsets relative to one another on a mounting surface such as a PCB or an integrated circuit substrate or package, rather than in a vertically stacked arrangement. In such applications, the depth or height dimension for the inductor core in a horizontal inductor assembly may be made larger than the depth or height dimension of a corresponding vertical inductor assembly, which enables more core material to be used in horizontal inductor assemblies relative to the core in a corresponding vertical inductor assembly, which produces a commensurate reduction in core losses relative to the vertical embodiments.

In some horizontal embodiments, for example, the core volume may form a cube. For example, the length, width, and height dimensions for the core volume in some horizontal embodiments may be on the order of 6 mm, 6 mm, and 6 mm, respectively. In other embodiments, other dimensions and proportions may be used.

Multiple specific embodiments have been described above and in the appended claims. Such embodiments have been provided by way of example and illustration. Persons having skill in the art and having reference to this disclosure will perceive various utilitarian combinations, modifications and generalizations of the features and characteristics of the embodiments so described. For example, steps in methods described herein may generally be performed in any order, and some steps may be omitted, while other steps may be added, except where the context clearly indicates otherwise. Similarly, components in structures described herein may be arranged in different positions or locations, and some components may be omitted, while other components may be added, except where the context clearly indicates otherwise. The scope of the disclosure is intended to include all such combinations, modifications, and generalizations as well as their equivalents.

1. A vertical patterned magnetic flux inductor system, comprising:
a magnetic core volume having a width extending from a left side to a right side of the core volume in an x direction, a length extending from a front side to a back side of the core volume in a y direction, and a depth extending from a top side to a bottom side of the core volume in a z direction, wherein the x, y, and z directions are mutually orthogonal, the x and y directions correspond to a horizontal dimension, and the z direction corresponds to a vertical dimension;
wherein the core volume defines a longitudinal gap that extends horizontally through the center of the core volume from its front side to its back side between top and bottom members of the core volume;
wherein the top and the bottom members of the core volume define complementary S shaped profiles when viewed in the z direction, each member including a front slot that opens at the front side of the member and a back slot that opens at the back side of the member, wherein each slot is oriented in the y direction, extends partially through the member, and is disposed adjacent to the left side or to the right side of the longitudinal gap;
a first longitudinal electrical conductor disposed partially in the back slot of the bottom member and partially in the front slot of the top member such that the first conductor slopes upward from the back slot of the bottom member to the front slot of the top member; and
a second longitudinal electrical conductor disposed partially in the back slot of the top member and partially in the front slot of the bottom member such that the second conductor slopes downward from the back slot of the top member to the front slot of the bottom member;
wherein a first terminal end of each of the electrical conductors is exposed at the top side of the core volume and a second terminal end of each of the electrical conductors is exposed at the bottom side of the core volume.

2. The inductor system of claim 1, wherein:
the top member and the bottom member are discrete components.

3. The inductor system of claim 1, wherein:
the core volume defines sloped cutout portions, each of which adjoins a respective inner end of one of the slots; and
each cutout portion has a slope angle and a contour configured to receive a respective one of the electrical conductors.

4. The inductor system of claim 1, wherein:
each terminal end of the electrical conductors comprises a vertical extension.

5. The inductor system of claim 4, wherein:
each of the vertical extensions has a longitudinal extension axis;
each of the electrical conductors has a longitudinal conductor axis;
the extension axes are parallel with one another; and
the conductor axes are neither colinear with nor are orthogonal to the corresponding extension axes.

6. The inductor system of claim 1, wherein:
the depth of the core volume is smaller than the width of the core volume and smaller than the length of the core volume.

7. The inductor system of claim 6, wherein:
the width of the core volume is equal to the length of the core volume.

8. The inductor system of claim 1, wherein:
the width of the core volume is equal to the length of the core volume.

9. A vertical patterned magnetic flux inductor system, comprising:
an inductor assembly comprising a magnetic inductor core that defines a core volume, wherein the core volume has a width from a left side to a right side of the core volume in an x direction, a length from a back side to a front side of the core volume in a y direction, and a depth from a top side to a bottom side of the core volume in a z direction, wherein the x, y, and z directions are mutually orthogonal, the x and the y directions correspond to a horizontal dimension, and the z direction corresponds to a vertical dimension;
wherein the inductor core defines a longitudinal gap that passes through the core volume in the y direction;
wherein the inductor core forms a three-dimensional flux path around the longitudinal gap whose projection onto the x-y plane forms a figure eight pattern with its two lobes oriented in the x direction; and
further comprising first and second electrical conductors spaced apart in the x direction and passing through the core volume and through the longitudinal gap in respective y-z planes such that the inductor core causes inverse coupling between the conductors when electric current flows through the conductors in the same direction but causes positive coupling between the conductors when electric current flows through the conductors in opposite directions;
wherein a longitudinal axis of the first electrical conductor slopes upward from the back side of the core volume to the front side of the core volume, and a longitudinal axis of the second electrical conductor slopes downward from the back side of the core volume to the front side of the core volume; and
wherein a first terminal end of each of the electrical conductors is exposed at the top side of the core volume, a second terminal end of each of the electrical conductors is exposed at the bottom side of the core volume, and the assembly is configured to be mounted to an additional component disposed vertically below the assembly.

10. The inductor system of claim 9, wherein:
the additional component comprises a printed circuit board (“PCB”) that is generally planar in the horizontal dimension.

11. The inductor system of claim 9, wherein:
the additional component comprises a driver and MOSFET (“DrMOS”) package.

12. The inductor system of claim 9, wherein:
the core volume defines cutout portions that face the longitudinal gap and that are sloped in the respective y-z planes; and
each cutout portion is configured to receive a respective one of the electrical conductors.

13. The inductor system of claim 9, wherein:
each terminal end of the electrical conductors comprises a vertical extension.

14. The inductor system of claim 13, wherein:
each vertical extension defines a longitudinal extension axis;
the extension axes are parallel with one another; and
the longitudinal conductor axes are neither colinear with nor are orthogonal to the corresponding extension axes.

15. The inductor system of claim 9, wherein:
the depth of the core volume is smaller than the width of the core volume and smaller than the length of the core volume.

16. The inductor system of claim 15, wherein:
the width of the core volume is equal to the length of the core volume.

17. The inductor system of claim 9, wherein:
the width of the core volume is equal to the length of the core volume.

18. The inductor system of claim 9, wherein:
the inductor core comprises two or more discrete magnetic core members in fixed relationship with one another.
